(19) United States
(12) Patent Application Publication
(10) Pub. No.: US 2020/0230920 A1
(43) Pub. Date: Jul. 23, 2020

(54) SAFETY GLASS STACK

(71) Applicant: AM7VISION GMBH, München (DE)

(72) Inventors: Leo KELLER, Rüti (CH); Martin HAINFELLNER, Geretsried (DE)

(73) Assignee: AM7VISION GMBH, München (DE)

(21) Appl. No.: 16/490,792

(22) PCT Filed: Mar. 6, 2018
(86) PCT No.: PCT/EP2018/055513

§ 371 Date: Nov. 14, 2019

(30) Foreign Application Priority Data
Mar. 6, 2017 (DE) 10 2017 203 627.3

(51) Int. Cl. B32B 17/10

(52) U.S. Cl. CPC B32B 17/10036; B32B 17/10761; G02F 1/13363; B32B 17/10788; B32B 17/10293; B32B 17/10174

(57) ABSTRACT

Adaptive laminated panel element for a vehicle window to reduce the effect of glare of a light source comprising a first panel and a second panel, a liquid crystal layer, and at least one connecting layer for connecting the first panel and the second panel with a spacing with respect to one another, wherein the liquid crystal layer is arranged between the first panel and the second panel or is applied to a surface of one of the first panel or the second panel, and wherein transparency of the adaptive laminated panel element is varied by controlling the liquid crystal layer via electrodes, and wherein the connecting layer is a birefringence-free adhesive layer and the laminated panel element is configured as safety glass for use as a vehicle window.

### TECHNICAL FIELD

The present disclosure relates to an adaptive laminated panel element for a vehicle window or a helmet visor and to a method for producing the adaptive laminated panel element, wherein the laminated panel element includes at least one liquid crystal layer (LCD layer).

### BACKGROUND

Windscreens and sliding roofs as well as side windows and rear windows for vehicles in particular have the function of protecting the occupants of the vehicle and delimiting the interior of the vehicle from the surroundings and at the same time making it possible to see the surroundings from inside of the vehicle. Increasingly being proposed are panels which have tints to modulate the irradiation of light into the vehicle or which have fine leads to enable heating of the panels.

To reduce the incidence of light through a transparent panel into the eyes of persons in the vehicle, various devices such as, for example, sun visors, sun blinds, dark adhesive films for transparent panels, rear windows which can be darkened, tinted window anti-glare lamps etc. are used. However, these devices have disadvantages of an invariable constant light attenuation, a complete darkening of the entire field of view of a transparent window by tinting or complete optical suppression by the dimming means.

### SUMMARY OF THE DISCLOSURE

The present disclosure addresses the aforesaid disadvantages and describes an adaptive laminated panel element for a vehicle window or a helmet visor by which the glare effect due to light sources can be avoided or reduced.

The object of the present disclosure is to provide an adaptive laminated panel element for a vehicle window or a helmet visor. In particular, it is an object to provide a device for reducing the glare for the occupants or the driver of a vehicle. A further object is in particular also to provide an optimized adaptive device for adjustable reduction of the glare onto the vehicle occupants or a helmet wearer.

An adaptive laminated panel element for a vehicle window or a helmet visor can include a first and a second panel, a liquid crystal layer and at least one connecting layer. The connecting layer can be provided for connecting the first and second panel with a spacing with respect to one another. The liquid crystal layer can be arranged between the first and second panel and/or can be applied to a surface of a first or second panel and preferably glued thereon. The transparency of the adaptive laminated panel element can be varied by controlling the liquid crystal layer via electrodes. As a result of this advantageous adaptive laminated panel element, by using the liquid crystal layer it is possible to provide a panel for a vehicle or a helmet visor which can be darkened by control via electrodes so that the glare effect for the driver or helmet wearer can be accordingly reduced or avoided. The panel can in this case be configured to be flat or in many cases, three-dimensionally curved. The liquid crystal layer can be provided on the inner side of the adaptive laminated panel element and thus attached to an outer surface of the first or second panel. In addition, the liquid crystal layer can be integrated between the first and second panel or preferably laminated therein. The laminated panel element can be configured as a safety glass for use as vehicle window. Safety glass should be understood in particular as a panel structure which meets the requirement in accordance with the ECE Regulation R43: Addendum 42, Revision 3, August 2009, 2012. The adaptive laminated panel element can advantageously also be used for building glazing, aircraft passenger windows, ships and boats.

A further advantage of the present disclosure is the additional sound damping which can be achieved by the adaptive laminated panel element. In particular, the connecting layer together with the liquid crystal layer between the first and second panel allows an additional reduction in sound when the laminated panel element is used, for example, in a vehicle.

The adaptive laminated panel element can be configured as a sunroof of a vehicle to protect the driver from incident light. By means of an electric field, it is possible to lighten or darken parts or the entire area of the adaptive laminated panel element with the liquid crystal layer. The switching times in this case are preferably <1 second and further preferably <0.5 seconds. As a result of these short switching times it is possible to switch the adaptive laminated panel element very rapidly from a state of maximum light transparency to a state of reduced light transparency so that a glare effect can very rapidly be reduced or cancelled out.

Advantageously the liquid crystal layer can be controlled in such a manner that the switching times can be switched continuously in speed. The liquid crystal layer is therefore advantageously configured in such a manner that the switching speed can be adjusted continuously.

In order to control an adaptive laminated panel element for a vehicle window, the apparatus and the method for avoiding or reducing the effect of glare in accordance with DE 10 2011 084 730 A1 can be used. The disclosure content of the document DE 10 2011 084 730 A1 is included in the present application in its full scope.

An adaptive laminated panel element can be provided which has a layer structure with a first and second panel, a liquid crystal layer and at least one connecting layer for connecting the first and second panel with a spacing with respect to one another, wherein the refractive index and the arrangement of the layers and layer thicknesses are configured in such a manner that the regulations in accordance with ECE Regulation R43, Addendum 4.2, Version 3, Aug. 29, 2012 can be fulfilled.

An adaptive laminated panel element can be configured as safety glass for use as a vehicle window. Particularly preferably to this end, the first panel has a thickness in the range of 2.5-3.5 mm, the liquid crystal layer with connecting layer has a thickness in the range of 1-1.5 mm and the second panel has a thickness in the range of 2-3 mm. As a result, the requirements for a safety glass with optimal weight and transmission behaviour can be achieved.

In the present case, vehicles are to be understood in particular as motor vehicles (passenger cars, lorries, coaches) as well as motorcycles and in the wider sense also rail vehicles, water vehicles and aircraft. A further advantage for the use of the adaptive laminated panel element for the glazing of vehicles should be seen in particular in the better control of the air conditioning in the vehicle interior, and the possibility of targeted shading of the vehicle interior.

The adaptive laminated panel element can have an index-adaptation means which enables an almost Fresnel-reflection-free laminated panel element to be provided.

Further preferably, the liquid crystal layer of the adaptive laminated panel element can be configured as a polarization-free, homeotropically aligned structure so that the transmission requirements in accordance with ECE Regulation R43, addendum 4.2, Revision 3, Aug. 29, 2012 can be satisfied. In addition, the liquid crystal layer can be configured as an electrically controllable, birefringent nematic liquid display to enable maximum contrast ratios so that such a laminated panel element can be used in particular as a side window or sunroof of a vehicle.

Advantageously the liquid crystal layer is divided into different segments so that it is possible to darken or lighten only special regions of the laminated panel element so that the glare effects can be reduced in a particularly targeted manner without simultaneously achieving an excessive darkening.

The adaptive laminated panel element can be integrated in a vehicle with a control system in such a manner that an automatic darkening of the laminated panel element is possible.

Advantageously, the laminated panel element can have various coatings wherein by means of a suitable choice of materials, glare protection in the spectral range from 380 to 780 nm can be optimized. In addition, the properties of the laminated panel element for the spectral range from 280 to 400 nm and 780 to 3000 nm can be advantageously modulated by a suitable choice of materials for the coatings. An advantageous coating thus in particular may include a structure and/or a material composition which allows the electromagnetic radiation in the range between 280 to 400 nm and in the range from 780 to 3000 nm to be reduced. To this end, in particular IR filter layers and/or UV filter layers are provided. This results in the further advantage that any heating of the interior of the vehicle can be reduced since specific electromagnetic radiation can be blocked.

The adaptive laminated panel element can have a connecting layer which is a birefringence-free adhesive layer. Due to this advantageous configuration, it is possible to further improve the transmission properties of the laminated panel element so that the maximum transmission of the laminated panel element is preferably >70%. By using the birefringence-free adhesive layer as connection between the first and second panel, it is additionally possible to provide a safety glass for use as a vehicle window. In particular, this safety glass fulfils the requirements of ECE Regulation R43: Addendum 42, Revision 3, Aug. 29, 2012.

Advantageously, the laminated panel element includes at least one anti-reflection coating so that the maximum transmission of the laminated panel element is >70%.

Advantageously, the laminated panel element includes a liquid crystal layer such as an electrically controllable birefringent nematic liquid display with a gap width of preferably 2-25 ∥m and a phase delay parameter of preferably 0.5 to 0.7 xλ and a liquid crystal material which shows a negative dielectric anisotropy, wherein a compensation means is provided to compensate for the light loss of crossed polarization films and the homeotropic alignment of the liquid crystal layer at greater angles of incidence of the light.

The compensation means can in particular at least include a uniaxial negative λ/2 C plate with a preferred delay in relation to the direction of incidence x and/or y (in the x-y plane of the panel element) of 200-300 nm and a negative biaxial λ/2 plate with a preferred delay in relation to the direction of incidence z (along the thickness z of the panel element) of 20-150 nm. The information nm relates here to a distance by which the corresponding direction of incidence of the linear polarization is delayed (x, y) and (z).

The liquid crystal layer between the first and second panel is advantageously provided by means of a birefringence-free adhesive layer as connecting layer between the panels. As a result of this advantageous configuration, the advantageous transmission values of the laminated panel element can be achieved.

The laminated panel element can particularly preferably have optical filter layers to reduce the electromagnetic radiation in the ultraviolet spectrum. Preferably optical filter layers are provided which are configured in such a manner that a reduction in the electromagnetic radiation at a wavelength of up to 400 nm to less than 1% is achieved.

Advantageously, additionally or alternatively to the aforesaid filter layers, further filter layers can be provided to reduce the incident electromagnetic radiation. Advantageously these optical filter layers are adapted in such a manner that the electromagnetic radiation can be reduced to less than 0.8% at a wavelength of 780 nm to 3000 nm.

The adaptive laminated panel element advantageously includes a liquid crystal layer which includes a nematic liquid crystal substance.

The liquid crystal layer can advantageously be switched at least into a first state in which the transparency is maximized and into a second state in which the transparency is minimized so that the laminated panel element can be darkened or lightened. In an advantageous further development it is possible to provide additional states between this first state and the second state which make it possible to provide different gradations of the darkening of the laminated panel element (continuous switching is particularly preferred).

The liquid crystal layer of the laminated panel element is advantageously divided into segments. These segments can each be controlled individually and can be darkened individually. Advantageously gaps having a width of 20 to 60 μm are provided between the electrodes of the liquid crystal layer. As a result of this small gap spacing between the electrodes of the liquid crystal layer, it is possible to improve the optical properties of the laminated panel element and in particular it is possible to make the segmenting of the liquid crystal layer almost invisible to the human eye. Perturbing segment transitions are therefore not discernible.

Advantageously the liquid crystal layer includes different segments wherein the spacing of two adjacent segments is <70 μm. By means of this small spacing it is possible to further increase the optical properties of the laminated panel element.

A gap is provided between two adjacent segments which remains free so that no boundaries are provided between adjacent segments (=boundary-free segment arrangement). As a result of avoiding boundaries between adjacent segments, it is possible to achieve a very small spacing between two adjacent segments so that the optical properties of the laminated panel element can be further improved. In particular, reflections of the segment transitions are avoided.

The laminated panel element can include a liquid crystal layer which is a polarizer-free liquid crystal display layer alternating positive phases having a gap thickness of 2 to 25 μm and a d/p ratio of the LC director of the liquid crystal layer between 0.5 and 2. This particularly advantageous liquid crystal layer enables a further improvement in the transmission properties of the laminated panel element and an optimal control of the laminated panel element with optimized switching times. The spacing of the electrode substrates of the liquid crystal layer is d in this case and the increase of the LC director (liquid crystal director) of the liquid crystal substance is designated by p.

The liquid crystal layer of the laminated panel element can comprise a liquid crystal material which shows a negative dielectric anisotropy and which in the switched-off state (in particular voltage-free state) has a homeotropic alignment. This advantageous configuration enables the optical properties of the laminated panel element to be further optimized and ensure a safe use as vehicle window.

Particularly preferably the liquid crystal layer comprises an electrically controllable birefringent nematic liquid display. This liquid display preferably has a gap width of 2 to 8 μm and a phase delay parameter of 0.5 to 0.7 xλ and a liquid crystal material which shows a negative dielectric anisotropy. Advantageously, compensation means are additionally provided to compensate for the light loss of crossed polarization films and the optically anisotropic homeotropically aligned liquid crystal layer.

Advantageously the liquid crystal layer includes a plastic substrate with a thickness of 50 to 300 μm.

Preferably the liquid crystal layer additionally includes a glass substrate having a thickness of 50 to 150 μm.

An adaptive laminated panel element can advantageously include the following components in the given order: first panel of glass/adhesive film as connecting layer/polarization filter film/liquid crystal layer polarization filter film/adhesive film as connecting layer/second panel of glass. This particularly preferred structure makes it possible to form a laminated panel element which is particularly suitable for safe use as a vehicle window.

An adaptive laminated panel element can advantageously include the following components in the given order: first panel of glass or plastic/adhesive layer of EVA, COP or PU/polarization filter layer of TAC-PVA-TAC/adhesive layer of OCA (OCA=optically clear adhesive)/liquid crystal layer with spacer from a gap thickness of 6 μm/adhesive layer of OCA/polarization filter of TAC-PVA-TAC/adhesive layer of EVA, COP or PU/second panel of glass or plastic. This particularly preferred structure makes it possible to form an adaptive laminated panel element which has optimal optical properties for use in automobile manufacture.

Advantageously the refractive indices of the layers of the laminated panel element are matched to one another in such a manner that the transmission through the laminated panel element is maximized and preferably the maximum transmission of the laminated panel element is 70%. This is achieved in particular by minimizing the reflection losses.

A windscreen can advantageously be constructed using an aforesaid adaptive laminated panel element. Particularly advantageously, the windscreen includes a number of segmented liquid crystal layers which are arranged between the first panel and the second panel and/or are applied to a surface of one of the first panel or the second panel, wherein the segments are arranged along the surface of the windscreen (along the curved or flat surface of the windscreen), and wherein these segments are preferably arranged in the vertical or horizontal direction along the surface of the windscreen.

Advantageously the above-described adaptive laminated panel element can be used as part of a vehicle glazing, an automobile glazing or a helmet visor.

Further preferably the automobile glazing is a glazing in the vehicle interior, in particular a glazing of separating panels, decorative surfaces or functional surfaces or a glazing which separates a vehicle interior from the outer surroundings of the vehicle, in particular a window or door glazing.

A method for producing the above-described adaptive laminated panel element can include the steps:
providing a first transparent panel and a second transparent panel,
laminating a liquid crystal layer between the first panel and the second panel using at least one connecting layer,
sealing the lateral edge regions of the laminated panel element with the aid of a sealing material.

The adaptive laminated panel element can advantageously include a coating on the first panel or the second panel, wherein this coating has a refractive index of <⅛ and a layer thickness of <250 μm. Preferably the coating is constructed of a plurality of individual layers.

The adaptive laminated panel element can advantageously include two index matched layers so that by corresponding configuration of these index matched layers, a maximum transmission of the laminated panel element is ≥70%.

The laminated panel element can include optical filter layers, wherein these optical filter layers advantageously include at least one UV thin layer edge filter and/or a plastic film with worked-in dye and/or a UV thin layer edge filter and/or an IR thin layer edge filter.

The optical filter layer can advantageously include a plastic film with an integrated or applied reflecting or absorbing material.

The laminated panel element can advantageously include two antireflection coatings, wherein at least one antireflection coating contains titanium dioxide or silicon dioxide.

The adaptive laminated panel element can advantageously include a first panel and/or a second panel, which is configured as panel safety glass, wherein preferably the first panel and the second panel are transparent to visible light.

The connecting layer can preferably contain at least one of the following materials: PVB (polyvinyl butyral), PET (polyethylene terephthalate), PVC (polyvinyl chloride), PU (polyurethane), COP (cyclic olefin polymer), EVA, co-PC (co-polycarbonate).

The liquid crystal layer can be arranged with the aid of two adhesive films or adhesive materials between the panels, which are glass panels. Alternatively, the panels can also include transparent flexible or non-flexible plastic.

An antireflection coating can be applied to at least one side of the first panel or the second panel which contains a structure of thin layers of dielectric material with alternately high and low refractive index. As a result of this advantageous configuration, the optical properties of the laminated panel element can be further enhanced.

Advantageously the antireflection layer includes a material of niobium oxide.

Preferably a laminated panel element is proposed which includes layers having as far as possible the same refractive index.

The adaptive laminated panel element can additionally have a heat-insulating layer which can also be used as a sun protective layer in order to achieve a high thermal insulation.

The first panel and the second panel of the adaptive laminated panel element can advantageously include a panel glass, a panel safety glass, partially pre-stressed single-panel glass, laminated safety glass or laminated safety glass with single-panel safety glass.

The aforesaid coatings can preferably be applied by cathode sputtering in vacuum (sputtering technique), by physical vapour deposition, by chemical gas phase deposition, by centrifugal methods or by a dipping method directly onto the first panel and/or the second panel.

The adaptive laminated panel element can comprise more than the first and the second panel and in particular three, four or five panels can be present, preferably including glass and/or plastic.

The connecting layer can preferably be configured as film and in particular as PVB film or EVA film (ethyl vinyl acetate film). Alternatively it is also possible to connect the panels by means of a casting resin.

The liquid crystal layer can be configured as film which contains liquid crystals. Such a film enables the film to be switched from a darkened (crossed polarizers) state into a transparent state or conversely by applying voltages. In this case, the phase transition of the liquid crystals from a transparent strictly ordered structure which makes the film appear dark in transmission into a birefringent phase (the phase is delayed by 180° and thereby turns the linear polarization axis by exactly 90°) which transmits visible light, is switched (or conversely, depending on the liquid crystal mode used). The phase delay (δ) in this case follows the following approximation: δ≢2 π/λ (Δnd) (here λ is the wavelength of the light, d is the gap width and Δn is the difference of the extraordinary (nₑ) minus the ordinary (n_{c}) refractive index of the liquid crystal medium. The liquid crystal layer can be provided in the laminated panel element in such a manner that only a part of this laminated panel element has the liquid crystal layer so that the entire surface of the laminated panel element does not have the liquid crystal layer. Preferably the liquid crystal layer is merely provided in an edge zone of the laminated panel element and particularly preferably the liquid crystal layer is only present on an area of one third of the total area of the laminated panel element. By means of this configuration, it is possible to provide a laminated panel which has a darkenable region with a liquid crystal layer and in addition, a region without a liquid crystal layer.

An LCD panel for a sunroof (in particular of a vehicle) can particularly advantageously be provided with the described adaptive laminated panel elements. A plurality of laminated panel elements (preferably four) can form at least one (preferably four) LCD panel of a sunroof, wherein the laminated panel elements can be arranged in such a manner that the preferred viewing angle range is arranged in (preferably four) different quadrants and as a result a multidomain display comes into effect for the occupants of a vehicle.

The laminated panel element can preferably have a circumferential seal which seals the region between first and second panel. The layers between the panels can thereby be sealed with respect to the outside. Preferably the circumferential seal is a PUR seal (polyurethane) which seals the laminated panel element (glass sandwich) and floatingly embeds the liquid crystal element (or liquid crystal layer). The particularly advantageous floating embedding can be achieved by using a soft material (such as preferably PUR) for the circumferential seal.

A method for producing the laminated panel element advantageously comprises a low-pressure/low-temperature plastic injection moulding method, in particular for applying the circumferential seal. Advantageously a tool (steel tool) is built around the panels which has several injection nozzles on the circumference. A low-melting plastic (preferably about 100-150° C. can then be injected at low pressure (preferably about 0.2-0.4 MPa as a seal between the first and second panel. The panel thus acquires a clean seal, is resistant to environmental influences and can be installed without further measures.

By means of the described configurations of the laminated panel element, it is additionally possible to achieve the advantageous transmission values of the entire laminated panel element of >70%.

It should be pointed out that the described features can be used alone and in combination with one another insofar as this is deduced in particular for the person skilled in the art. In particular, all the features described in this document can be combined with one another in any way. This applies particularly to the features set out in the claims.

### BRIEF DESCRIPTION OF THE DRAWINGS

The disclosure is described hereinafter by means of examples with reference to the appended figures.

FIG. 1: shows the structure of a conventional safety glass;

FIG. 2: shows a first structure of the adaptive laminated panel element according to an embodiment of the present disclosure;

FIG. 3: shows a second structure of the adaptive laminated panel element of according to an embodiment of the present disclosure;

FIG. 4: shows a third structure of the adaptive laminated panel element according to an embodiment of the present disclosure;

FIG. 5a: shows the structure of a windscreen using the adaptive laminated panel element according to an embodiment of the present disclosure;

FIG. 5b: shows a structure of a side window/sunroof using the adaptive laminated panel element according to an embodiment of the present disclosure;

FIG. 6: shows the spectral transmission range of the adaptive laminated panel element according to an embodiment of the present disclosure;

FIG. 7a: shows a further advantageous structure of the adaptive laminated panel element according to an embodiment of the present disclosure;

FIG. 7b: shows the structure of the adaptive laminated panel element with circumferential seal according to an embodiment of the present disclosure;

FIG. 8: shows a table of a particularly advantageous exemplary embodiment of the laminated panel element according to an embodiment of the present disclosure;

FIG. 9: shows the structure of a sunroof with four LCD panels according to an embodiment of the present disclosure.

### DETAILED DESCRIPTION

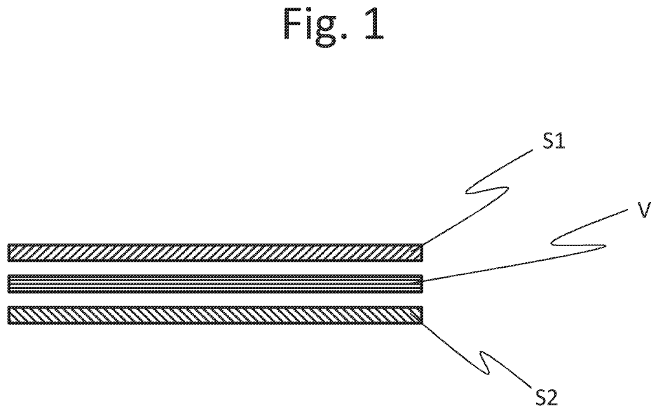

FIG. 1 shows as an example the structure of a conventional safety glass, such as is used, for example, in vehicle building. The safety glass here consists of a first panel S1 which is adhesively bonded to a second panel S2 by means of a connecting layer V.

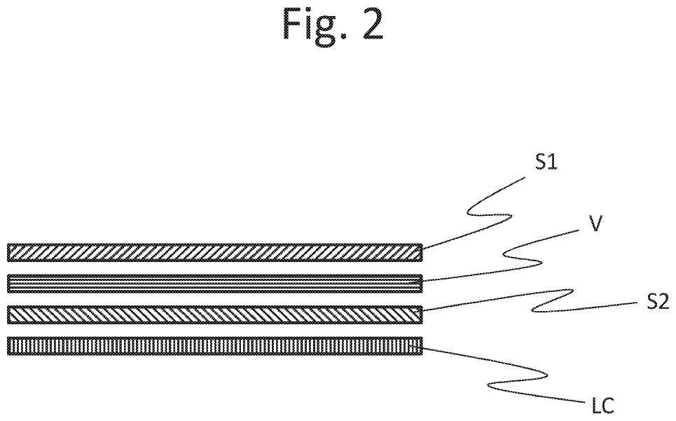

FIG. 2 shows a structure of an adaptive laminated panel element according to the present disclosure. According to this first exemplary embodiment, a first panel S1, which preferably includes a glass material, is provided. The first panel S1 has an outer surface which remains free and an inner surface which is in contact with the connecting layer V. Via the connecting layer V it is possible to make a connection between the first panel S1 and the second panel S2 and thereby ensure a spacing between the panels S1 and S2. This structure thus corresponds to the structure of a safety glass. In addition, it is proposed to provide a liquid crystal layer LC on the surface of the second panel S2. In particular, the liquid crystal layer LC is provided on the inner side of the second panel S2.

The liquid crystal layer LC is preferably an LCD (liquid crystal display) film. The adaptive laminated panel element shown can advantageously be used for the windscreen of a vehicle, wherein particularly preferably the liquid crystal layer is divided into different segments. The liquid crystal layer LC is preferably constructed using an upper substrate and a lower substrate which are facing one another, wherein a liquid crystal material is inserted between these substrates. In a further development an upper polarization layer and a lower polarization layer can be provided on the outer side of the upper substrate and/or the lower substrate. Particularly preferred in addition is a compensating film which is positioned in the upper or in both polarization layers to reduce the dependence of optical properties on the viewing angle, wherein the compensating film in each case compensates for the light loss of crossed polarizers and the elliptical polarization of anisotropic, homeotropically arranged liquid crystals at larger angles of incidence. The compensation scheme follows the concept that the homeotropic liquid crystal layer (uniaxial, positive λ/2 C plate) is compensated with a uniaxial negative λ/2 C plate (e.g. COP). The light loss of crossed polarizers can, for example, be compensated with a positive and a negative uniaxial λ/6 plate or, again for example, with a biaxial λ/2 delay plate (x-y 220 nm, z 55 nm) (e.g. COP).

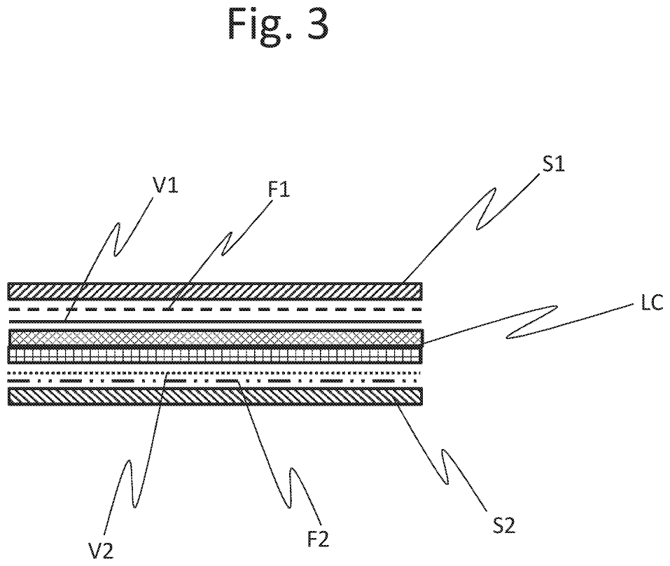

FIG. 3 shows a further advantageous embodiment of the adaptive laminated panel element. Various layers are provided between the first and second panel S1, S2. In particular, the liquid crystal layer LC is provided wherein in each case a connecting layer V1, V2 and an optical filter F1, F2 are provided between the liquid crystal layer LC and the first panel S1 and the second panel S2. The optical filters F1, F2 can be configured as an optical filter layer and in particular as a UV thin layer edge filter and/or IR thin layer edge filter.

The connecting layers V1, V2 are preferably constructed of at least one of the following materials: PVB, PET, PVC, PU, COP, EVA, or co-PC.

In the exemplary embodiment of FIG. 3 the liquid crystal layer LC is implemented as a positive phase-change LCD. By using a phase change LCD as a liquid crystal layer LC, it is possible to provide a structure which is particularly suitable for use as a windscreen of a vehicle. Thus, a windscreen for a passenger car or a lorry can particularly preferably be provided.

The connecting layers V1, V2 are each configured as a birefringence-free adhesive layer so that it is possible to form a laminated panel element which is suitable as safety glass for use as a vehicle window.

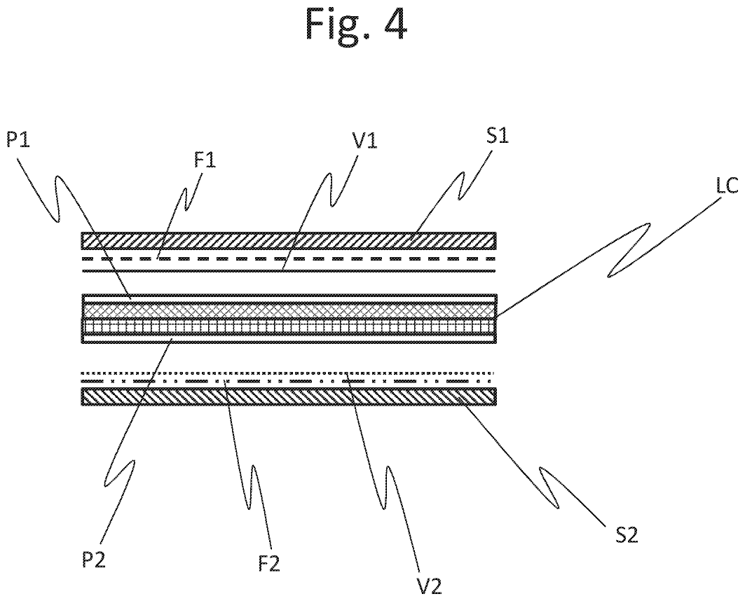

FIG. 4 shows a further advantageous embodiment of the adaptive laminated panel element according to the present disclosure. Optical filter layers F1, F2 are provided between the first panel S1 and the second panel S2. These optical filter layers are configured with the same refractive indices (index matching).

In addition, connecting layers V1 and V2 are provided which enable a safety glass to be formed. Additional polarization and compensating layers P1 and P2 are provided on the liquid crystal layer LC.

In this embodiment, the liquid crystal layer LC is configured as a birefringent nematic liquid crystal display so that this structure is particularly suitable for side windows and sun protective glazings.

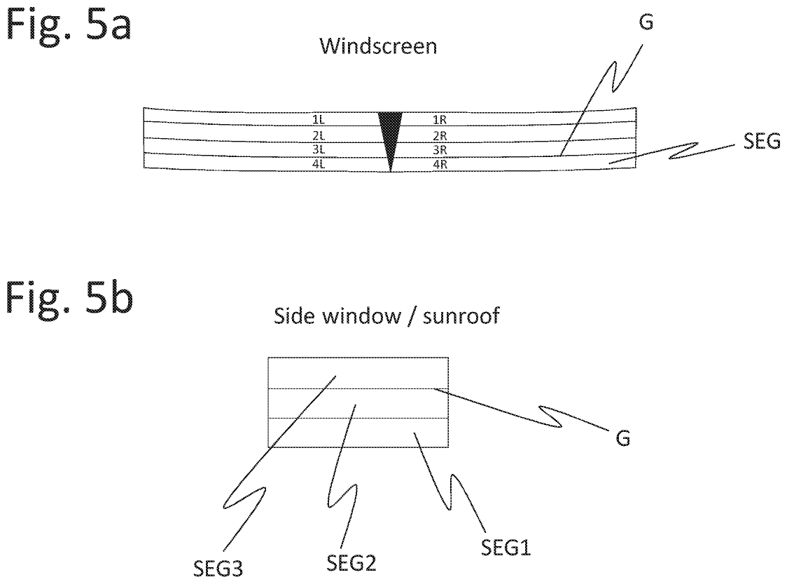

FIG. 5a shows a windscreen using an adaptive laminated panel element. This laminated panel element is divided into segments 1L to 4R and thus in the vertical and horizontal directions along the surface of the windscreen. The laminated panel element can however also have more than four segments. The individual segments of the windscreen can be controlled individually or jointly so that selectively different regions of the windscreen can be darkened. The individual segments SEG adjoin one another, wherein invisible gaps G are provided between the segments SEG. In particular, the gaps G are small in such a manner that are not perceivable visually for the human eye. Preferably the width of the gaps G is therefore less than 70 μm.

FIG. 5b shows the segmenting of a side window or sunroof. The adaptive laminated panel element is divided into three segments in this case as an example. The first segment SEG1, the second segment SEG2 and the third segment SEG3 are arranged adjacently, wherein an invisible gap G is provided between these segments. Preferably the structure of the liquid crystal layer LC described according to the exemplary embodiment according to FIG. 4 is used as liquid crystal layer LC.

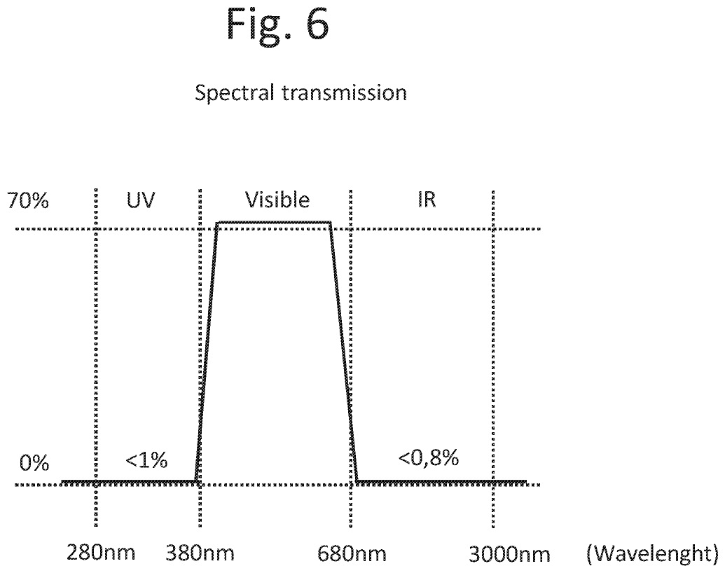

FIG. 6 shows the spectral transmission behaviour of the adaptive laminated panel element of the present disclosure. In particular, it can be seen from FIG. 6 that by providing the described optical filter for the infrared and UV range, the electromagnetic radiation up to a wavelength of 400 nm can be reduced to less than 1% and thus like the electromagnetic radiation at a wavelength in the range from 780 nm to 3000 nm can be reduced to <0.8%. The optical filters F1, F2 used in particular include a UV thin film edge filter (sputtered interference filter) or an absorbing substance, e.g. a dye which is worked into a plastic film. The UV filter can additionally be combined with an IR thin film edge filter or, for example, silver or copper can additionally be provided as a reflecting or absorbing material, which is applied to a plastic film or introduced. The two edge filters are used in transmission for the bandpass filter for the visible radiation according to FIG. 6.

Preferably the refractive indices of the layers used is optimized using Fresnel equations so that a maximum transmission of the safety glass is obtained so that reflection losses can be avoided.

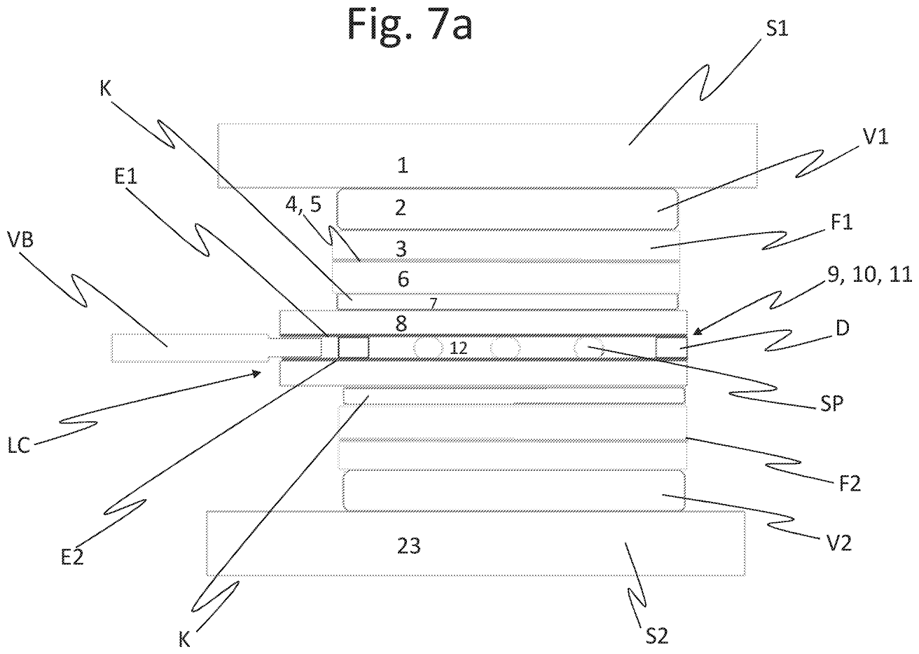

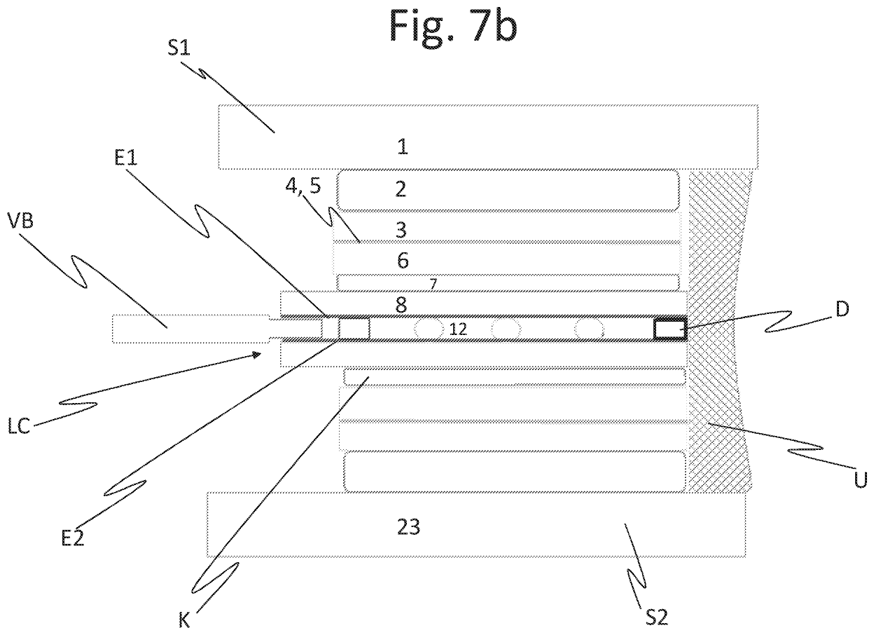

FIG. 7a shows a structure of a further advantageous embodiment of the present disclosure. The connecting layers V1 and V2 are provided between the first panel S1 and the second panel S2, which directly adjoin the first panel S1 and the second panel S2 and are connected to this. The preferred layer thickness of the first connecting layer V1 and the second connecting layer V2 is 125 μm in this case. A polarization layer or an optical filter F1, F2 is provided adjacent to the first connecting layer V1 and the second connecting layer V2. The optical filter F1, F2 additionally has a compensating layer. The compensating layer is integrated in the polarizer and the filters are applied to the polarizer. The compensating layer can be constructed to be reflecting and/or absorbing. The optical filter is connected via an adhesive layer K (or connecting layer) to the liquid crystal layer LC. The liquid crystal layer LC includes two LCD substrate layers 8 which each has electrodes E1, E2 on a surface. The electrodes E1, E2 are connected to a controller via the connecting element VB. A gap is provided between the facing electrodes E1 and E2, in which the liquid crystal material is located and spacers SP which are preferably constructed of plastic.

As shown in FIG. 7b, for additional sealing against environmental influences and for secure embedding of the liquid crystal element in the panel sandwich, the safety glass sandwich is overmoulded from a relatively soft material (preferably PUR) using a low-pressure (0.2-0.4 MPa) and low-temperature (100-140° C.) plastic injection moulding method so that a circumferential seal U (circumferential seal) can be provided. As a result, the laminated panel element acquires a clean seal, is resistant to environmental influences and can be installed without further measures. The seal embraces the entire region from glass S1 to glass S2 and seals the entire safety glass sandwich. The circumferential seal U is a PUR seal (gasket) which seals the glass sandwich and embeds the liquid crystal element in a “floating” manner since softer material is brought between the panels S1 and S2 to this end. The LCD seal D on the other hand seals the LCD completely towards the outside.

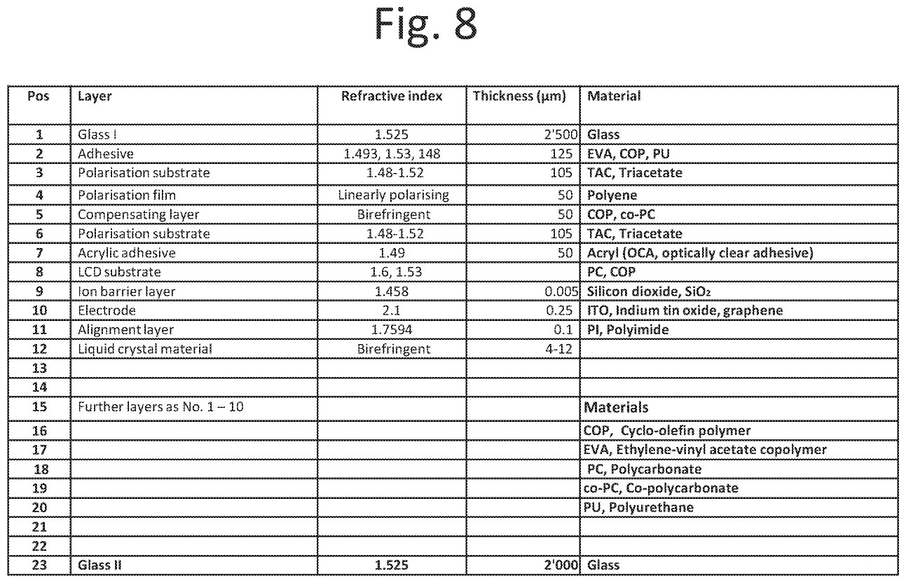

The table shown in FIG. 8 includes further details relating to the layer thicknesses and the refractive index and the preferred material of the layers of a particularly advantageous exemplary embodiment (see also FIG. 7).

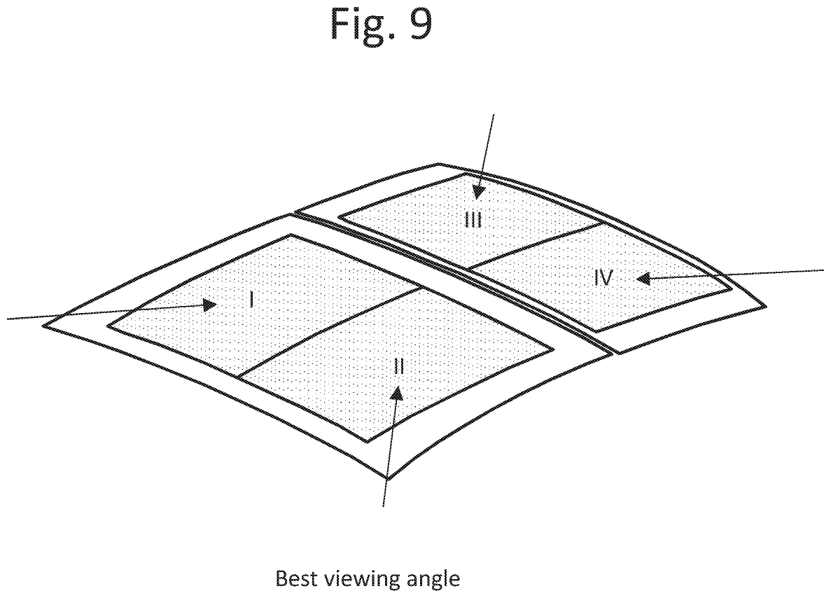

FIG. 9 shows the structure of a sunroof with four different LCD panels (I, II, III and IV). Each of these LCD panels can be configured as a laminated panel element wherein these are provided separately or in combination. The best viewing angle range (see arrows in FIG. 9) of the four displays (specific combination of the linear polarization axes and the direction of friction) is designed, for example so that for the vehicle occupants a four-domain configuration of the LCD roof is obtained. That is, the attenuation of the light through the sunroof is as uniform as possible for all the occupants for the most diverse direction of incidence of the sunlight.

It should be noted that the description and the figures merely set out the principles of the proposed apparatus. On the basis of the present disclosure, it is possible for the person skilled in the art to create various variants of the configurations described. These variants, although not expressly described, are also disclosed by this document and are covered by the claims.

1. Adaptive laminated panel element for a vehicle window to reduce the effect of glare of a light source comprising:
a first panel and a second panel;
a liquid crystal layer; and
at least one connecting layer for connecting the first panel and the second panel with a spacing with respect to one another, wherein the liquid crystal layer at least one of is arranged between the first panel and the second panel, or is applied to a surface of one of the first panel or the second panel, and wherein
transparency of the adaptive laminated panel element is varied by controlling the liquid crystal layer via electrodes, and
wherein the connecting layer is a birefringence-free adhesive layer and the laminated panel element is configured as safety glass for use as a vehicle window.

2. The adaptive laminated panel element according to claim 1, wherein the laminated panel element comprises at least one anti-reflection coating so that the maximum transmission of the laminated panel element is greater than 70%.

3. The adaptive laminated panel element according to claim 1, wherein the liquid crystal layer is provided between the first panel and the second panel, and birefringence-free adhesive layers are used as connecting layers between the liquid crystal layer and the first and second panels.

4. The adaptive laminated panel element according to claim 1, further comprising optical filter layers to reduce the electromagnetic radiation in the ultraviolet spectrum, wherein the filter layers are configured in such a manner that a reduction to less than 1% in the electromagnetic radiation at a wavelength of up to 400 nm is achieved.

5. The adaptive laminated panel element according to claim 1, further comprising optical filter layers to reduce the incident electromagnetic radiation to less than 0.8% at a wavelength of 780 nm to 3000 nm.

6. The adaptive laminated panel element according to claim 1, wherein the liquid crystal layer is divided into segments which each is controlled individually and darkened, and gaps having a width of 20-70 μm are present between electrodes of the liquid crystal layer.

7. The adaptive laminated panel element according to claim 6, wherein the spacing of two adjacent segments is less than 70 μm.

8. The adaptive laminated panel element according to claim 6, wherein no boundaries are provided between adjacent segments so that a free gap is present between adjacent segments.

9. The adaptive laminated panel element according to claim 1, wherein the liquid crystal material of the liquid crystal layer exhibits a negative dielectric anisotropy and wherein the liquid crystal layer in the switched-off state has a homeotropic alignment.

10. The adaptive laminated panel element according to claim 1, wherein the liquid crystal layer comprises an electrically controllable birefringent nematic liquid display with a gap width of 2-25 μm and a phase delay parameter of 0.5 to 0.7 xλ and a liquid crystal material which shows a negative dielectric anisotropy, wherein a compensation means is provided to compensate for light loss of crossed polarization films and the homeotropic alignment of the liquid crystal layer and wherein the compensation means comprises at least one of a uniaxial negative λ/2 C plate with a preferred delay in relation to a direction of incidence X or Y of 200-300 nm or a negative biaxial λ/2 plate with a preferred delay in relation to a direction of incidence Z of 20-150 nm.

11. The adaptive laminated panel element according to claim 1, wherein the liquid crystal layer (LC) comprises a plastic substrate having a thickness of 50 to 300 μm and/or wherein the liquid crystal layer comprises a glass substrate with a thickness of 50 to 150 μm.

12. The adaptive laminated panel element according to claim 1, wherein the laminated panel element comprises the following components in the given sequence: the first panel of glass, the adhesive film as connecting layer, the polarization filter film, the liquid crystal layer, the polarization filter film/adhesive film as connecting layer, and the second panel of glass.

13. The adaptive laminated panel element according to claim 1, having further comprising at least one index adaptation layer so that the maximum transmission of the laminated panel element is greater than or equal to 70%.

14. The adaptive laminated panel element according to claim 1, further comprising at least one of
an optical filter layer, which is a UV thin layer edge filter or a plastic film with worked-in dye and/or comprising an optical filter layer which comprises a UV thin layer edge filter and/or IR thin layer edge filter, or
an optical filter layer which comprises a plastic film with integrated or applied reflecting or absorbing material.

15. The adaptive laminated panel element according to claim 1, wherein the laminated panel element comprises two antireflection coatings and at least one antireflection coating contains titanium dioxide and/or silicon dioxide, and wherein an antireflection coating is applied to at least one side of the first panel or the second panel which contains a structure of thin layers of dielectric material with alternately a high refractive index and a low refractive index.

16. A LCD panel for a sunroof with adaptive laminated panel elements according to claim 1, wherein a plurality of laminated panel elements form at least one LCD panel of a sunroof, wherein the laminated panel elements are arranged in such a manner that the preferred viewing angle range is arranged in different quadrants and as a result a multidomain display comes into effect for the occupants of a vehicle.

17. A windscreen having an adaptive laminated panel element according to claim 1, wherein a plurality of segmented liquid crystal layers are provided, which are arranged between the first panel and the second panel and/or are applied to a surface of one of the first panel or the second panel and wherein the segments are arranged along the surface of the windscreen and preferably are arranged in the vertical direction or the horizontal direction.

18. Use of a laminated panel element according to claim 1, as part of a vehicle glazing or a helmet visor, wherein the glazing separates a vehicle interior from the external surroundings of the vehicle.

19. A method for producing an adaptive laminated panel element according to claim 1, comprising the steps:
providing the first panel and the second panel,
laminating the liquid crystal layer between the first panel and the second panel using at least one connecting layer,
sealing the lateral edge regions of the laminated panel element with aid of a sealing material.
